(19) United States
(12) Patent Application Publication
(10) Pub. No.: US 2011/0003265 A1
(43) Pub. Date: Jan. 6, 2011

(54) INDIRECT RESTORATION PLACEMENT TOOL AND PROCESS

(75) Inventor: Simon Paul McDonald, Katikati (NZ)

Correspondence Address: IPHORGAN, LTD., 1130 LAKE COOK ROAD, SUITE 240, BUFFALO GROVE, IL, 60089, US

(73) Assignee: Dental IP, Ltd., Katikati (NZ)

(21) Appl. No.: 12/830,416

(22) Filed: Jul. 5, 2010

(30) Foreign Application Priority Data
Jul. 6, 2009 (NZ) 578190
Aug. 31, 2009 (NZ) 579348

(51) Int. Cl. A61C 3/00

(52) U.S. Cl. 433/163

(57) ABSTRACT

A manufactured device for handling a dental restoration, the device comprising an adhesive receiving surface and handle adjacent thereto for grasping of the device by a dental hand tool such as a tweezer or forceps. The handle may also include a bore configured to receive the pins ends of the pin tweezer for grasping the device. The adhesive receiving surface is configured with varying dimensions and shapes to correspond to the different restorations. The adhesive receiving surface may also include lug portions for controlling the amount of adhesive to the device.

### CROSS-REFERENCE TO RELATED APPLICATIONS

This application claims priority to New Zealand Provisional Application Ser. No. 578190, filed Jul. 6, 2009, and New Zealand Provisional Application Ser. No. 579348, filed Aug. 31, 2009.

### FIELD OF THE INVENTION

The invention relates to a tool and process to assist dentists in making accurate and reliable placement of indirect dental restorations.

### BACKGROUND OF THE INVENTION

Handling small indirect dental restorations such as crowns, inlays, on-lays and veneers can be a difficult task due to the size, shape and highly polished surface of the restoration. During the handling process the dentist or technician fits the restoration into the patient's mouth. Then they wash, etch, and apply adhesive to the restoration thereby exposing it to varying temperatures and high moisture. The present invention provides a simple, reliable, secure, multiple release and pick-up method of handling such indirect dental restorations.

### SUMMARY OF THE INVENTION

A first embodiment of the present invention consists of a device for handling a dental restoration comprising a first adhesive receiving surface configured to receive an adhesive material, a second adhesive receiving surface adjacent to and overlapping the first adhesive receiving surface, a web portion interconnecting the first and second adhesive receiving surfaces, and a handle adjacent the first adhesive receiving surface for grasping and handling the device. The handle is configured to enable grasping of the device by a dental hand tool and may include a bore configured to receive the ends of a tweezers.

In one configuration, the first adhesive receiving surface is substantially circular and the second adhesive receiving surface is substantially circular. In another configuration, the first adhesive receiving surface is substantially oval and the device further includes a third and fourth adhesive receiving surface adjacent to and overlapping the first adhesive receiving surface wherein the surface area of the third and fourth receiving surfaces are each less than the surface area of the first adhesive receiving area. In this configuration, the second, third and fourth adhesive receiving surfaces comprise lugs disposed around the circumference of the first adhesive receiving surface. In a third configuration, the first adhesive receiving surface is substantially elongated in configuration and consists of a third adhesive receiving surface wherein the second and third adhesive receiving surfaces comprise lugs disposed at opposite ends of the first adhesive receiving surface.

The handle is disposed substantially perpendicular to the first adhesive receiving surface.

### BRIEF DESCRIPTION OF THE DRAWINGS

FIG. 1 shows a side elevation view of a first embodiment of the present invention;

FIG. 2 is a second side elevation view of a first embodiment of the present invention;

FIG. 3 is a bottom elevation view of a first embodiment of the present invention;

FIG. 4 is a top plan view of a first embodiment of the present invention;

FIG. 5 a third side elevation view of a first embodiment of the present invention;

FIG. 6 is a perspective view of a first embodiment of the present invention;

FIG. 7 shows a side elevation view of a second embodiment of the present invention;

FIG. 8 is a second side elevation view of a second embodiment of the present invention;

FIG. 9 is a bottom elevation view of a second embodiment of the present invention;

FIG. 10 is a top plan view of a second embodiment of the present invention;

FIG. 11 shows a third side elevation view of a second embodiment of the present invention;

FIG. 12 is a fourth side elevation view of a second embodiment of the present invention;

FIG. 13 is a perspective view of a second embodiment of the present invention;

FIG. 14 is a perspective view of a third embodiment of the present invention;

FIG. 15 is a side elevation view of a kit comprising multiple devices according to the present invention;

FIGS. 16-18 show the device according to the present invention in use.

### DETAILED DESCRIPTION OF THE DRAWINGS

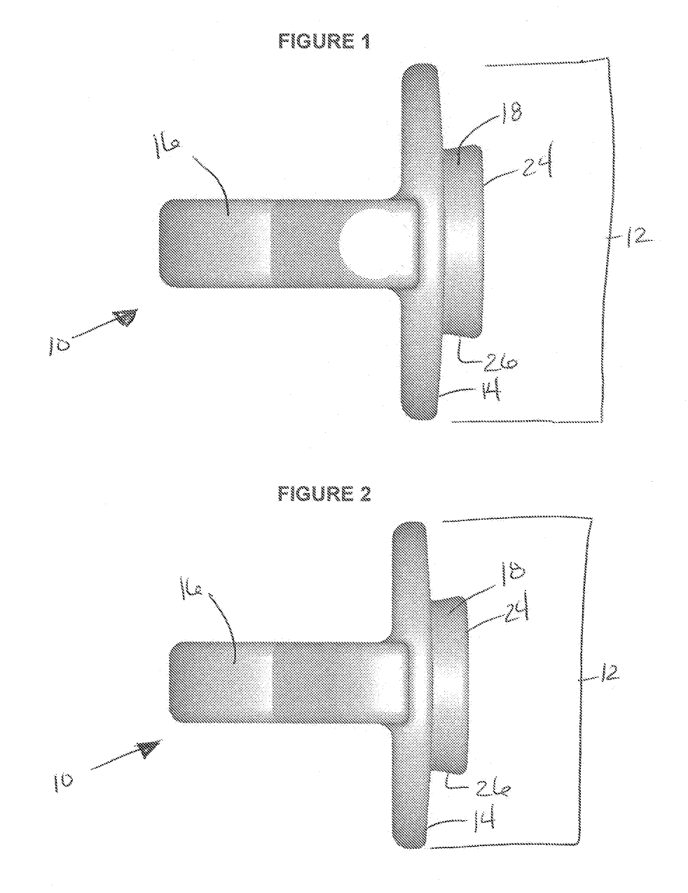

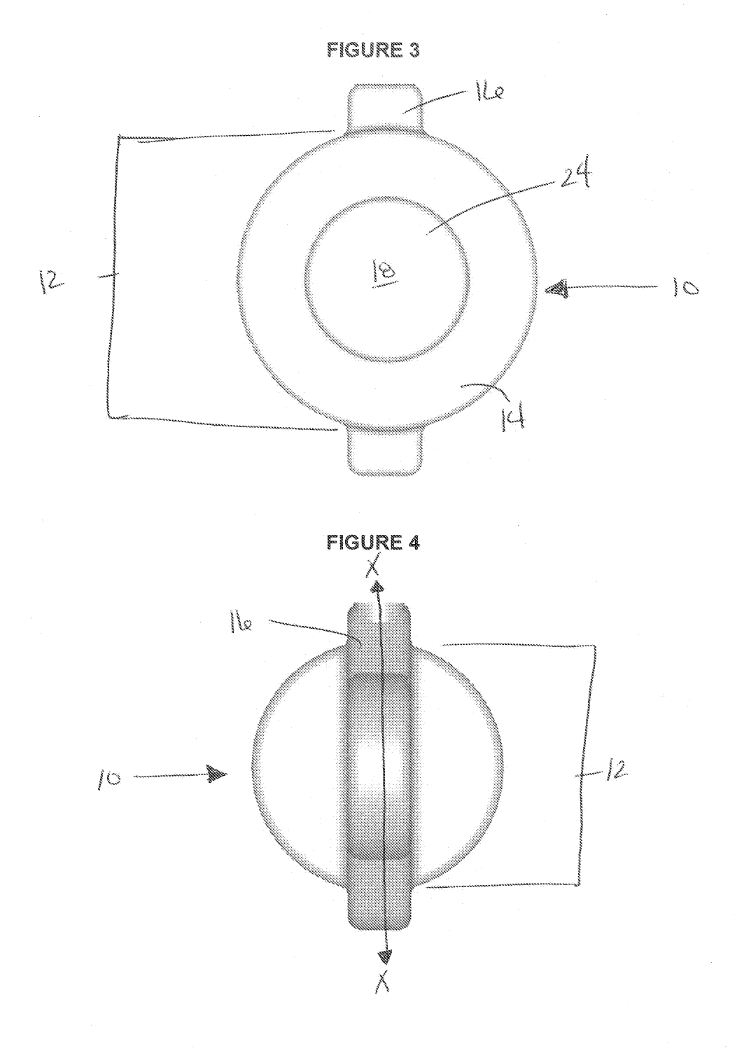

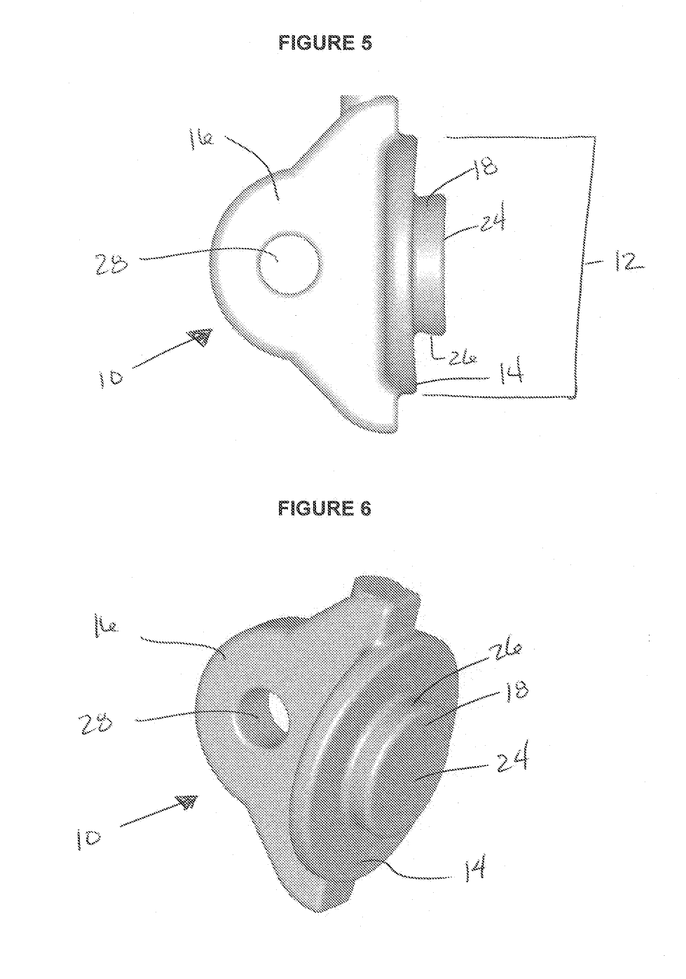

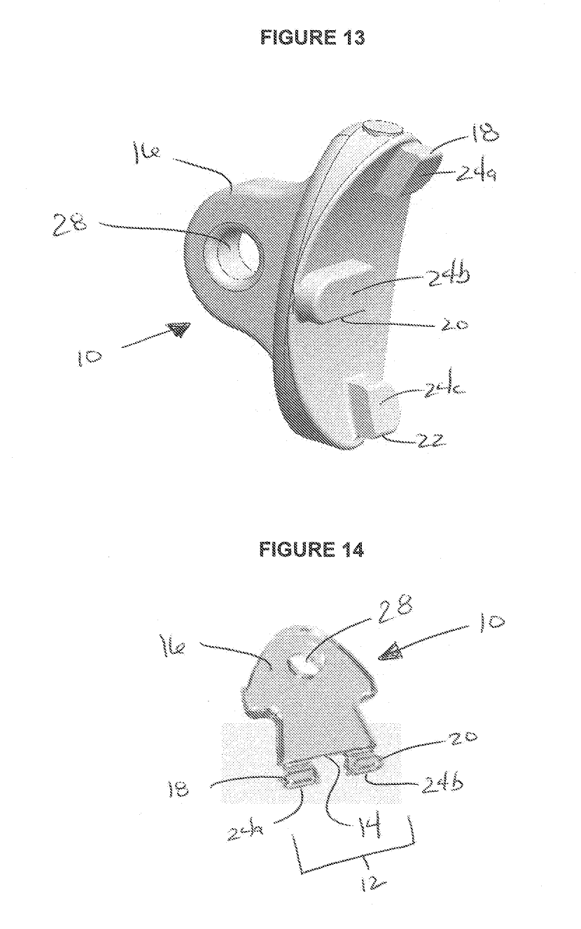

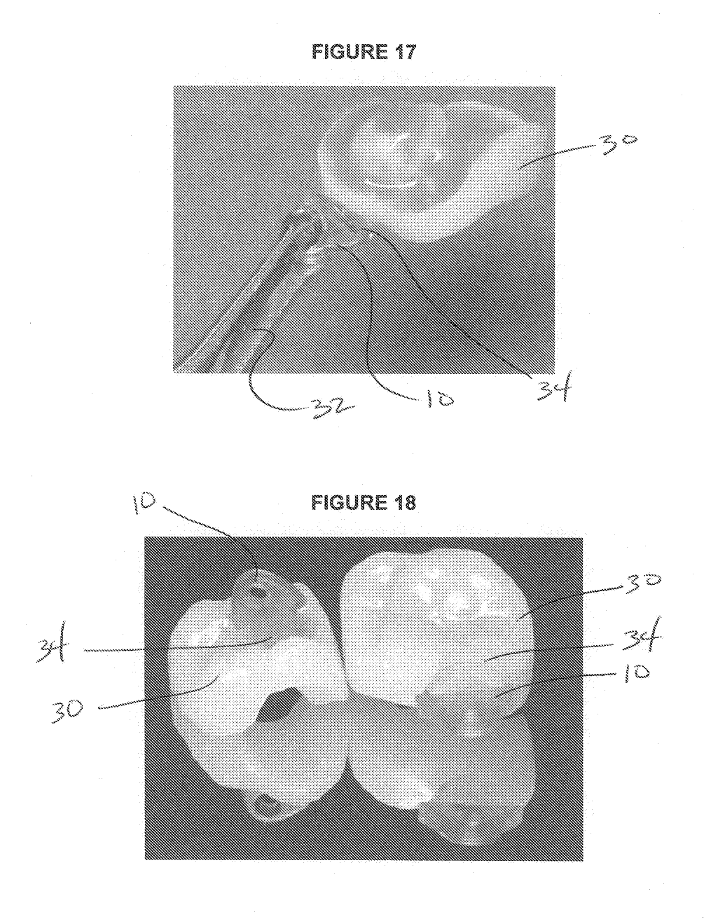

The present invention relates to a manufactured apparatus for assisting dental professionals in the handling and placement of indirect dental restorations, including crowns, inlays, on-lays, and veneers. FIGS. 1-18 show various elevation and perspective views of a first, second and third embodiment of the present invention and use of the present invention with an indirect dental restoration. Elements common to each embodiment will be assigned like reference numerals in each of the appended figures.

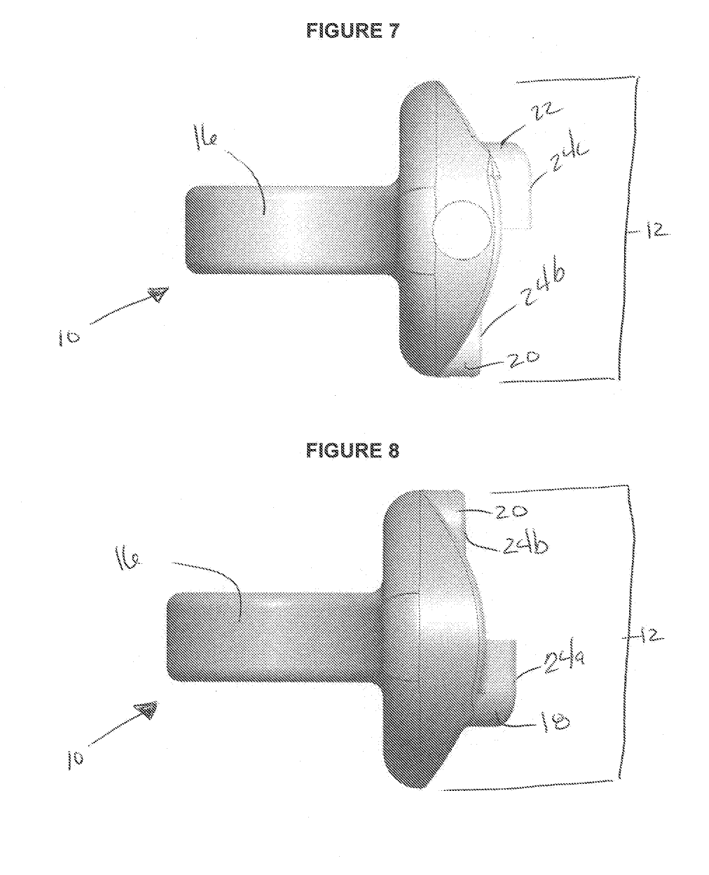

The device 10 generally comprises an adhesive receiving end 12 consisting of a first receiving surface 14 for receiving a curable adhesive for temporarily bonding a dental restoration to the device 10 and a handle 16 providing the dentist or dental technician with a surface to grasp the device 10 with a dental hand tool such as a tweezers, forceps or pin tweezers. The adhesive receiving end 12 is suitably sized in each of the embodiments described herein to address an indirect dental restoration of a given size. FIGS. 1-6 show a first embodiment of the present invention wherein the first adhesive receiving surface 14 is substantially circular and is generally intended for use with inlays, on-lays, veneers, and crowns. FIGS. 7-13 show a second embodiment of the present invention wherein the first adhesive receiving surface 14 is substantially oval in shape and is generally intended for use with crowns. FIG. 14 shows a third embodiment of the present invention wherein the first adhesive receiving surface 14 is substantially narrow and elongated in shape and is generally intended for use with inlays and veneers. It is contemplated that various configurations of the adhesive receiving end 12 described herein can be manufactured in a variety of sizes and shapes and that the configurations described herein can be used with indirect dental restorations other than those specified herein.

Referring to FIGS. 1-14, each of the embodiments described herein also include a second 18, third 20 and/or fourth 22 adhesive receiving surface consisting of a lug intended to control the quantity of the adhesive used and also intended to increase the contact surface area between the device 10 and adhesive as compared to the contact surface area of the adhesive to the restoration piece. The second 18, third 20, and/or fourth 22 adhesive receiving surfaces are adjacent to and overlapping the first adhesive surface 14.

In this arrangement, the force required to the break the temporary bond between the adhesive and device 10 will be greater than the force required to break the temporary bond between the restoration and adhesive. Thus when the restoration is to be released from the device 10, the adhesive will remain bonded to the device 10 with a smaller amount of residual adhesive left to clean off the surface of the restoration. Referring to FIGS. 1-6, the lug consists of a raised surface 24 and web or offset portion 26 connecting the raised adhesive receiving surface to the first adhesive receiving surface. While up to 3 lugs are shown in the appended figures and described herein, it is contemplated that any suitable number of lugs can be incorporated.

Turning to FIGS. 1-6, the first adhesive receiving surface 14 is substantially circular in configuration. The second adhesive receiving surface 18 is also substantially circular in configuration and the surface area of the second adhesive receiving surface 18 is preferably less that the surface area of the first adhesive receiving surface. Either the first or the second adhesive receiving surfaces 14, 18 can be formed concave to the handle 16 along the axis X-X shown in FIG. 4. Concave adhesive receiving surfaces assist in forming a secure bond with contoured surfaces of the restoration.

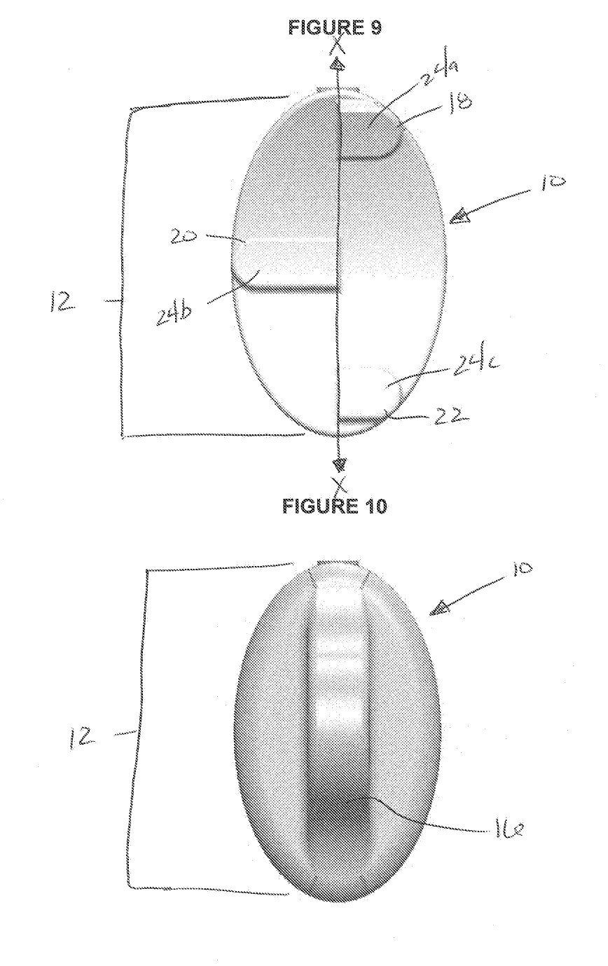

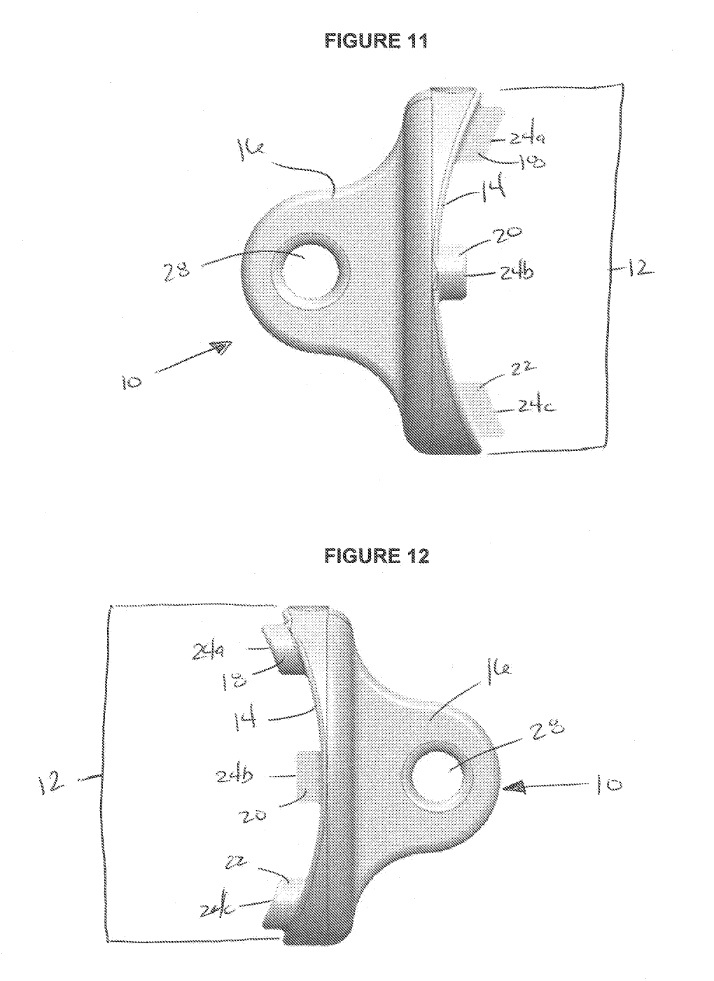

Referring to FIGS. 7-13, a second embodiment of the present invention is shown in which the first adhesive receiving surface 14 is substantially oval in configuration. As shown in FIGS. 11 and 12, the first adhesive receiving surface may also be formed concave to the handle 16 about the long axis (X-X in FIG. 9) of the first adhesive receiving surface 14. A second 18, third 20, and fourth 22 adhesive receiving surface consisting of lugs as described above are disposed about the axis X-X (FIG. 9) of the first adhesive receiving surface 14 and are adjacent to and overlapping with the first adhesive receiving surface 14. The raised surfaces 24a, b, c also may follow the concave configuration of the first adhesive receiving surface 14.

Referring to FIG. 14, a third embodiment of the present invention is shown in which the first adhesive receiving surface 14 is substantially narrow and elongated in configuration. A second and third adhesive receiving surfaces 18, 20 comprise lugs disposed at opposite ends of the first adhesive receiving surface 14.

In each of the first, second, and third embodiments of the present invention, a handle 16 is provided to enable the dental professional a surface to grab and handle the device 10 with a dental hand tool such as a tweezers or forceps. The handle 14 is generally a flat, tab-like structured disposed substantially perpendicular to the adhesive receiving end 12 and substantially perpendicular to the first adhesive receiving surface 14. In this configuration, the handle 16 may be easily grasped by the dental hand tool. The handle 16 also may include a bore 28 configured to receive the ends of a pin tweezers. In each of the embodiments described herein, the combined surface area of the first adhesive receiving surface 14 and either the second, third or fourth adhesive receiving surface 18, 20, 22 is greater than the largest cross-sectional surface area of the handle 16. In the first and second embodiments described herein, the surface are of the first adhesive receiving surface 14 is greater than the largest cross-sectional surface area of the handle 16.

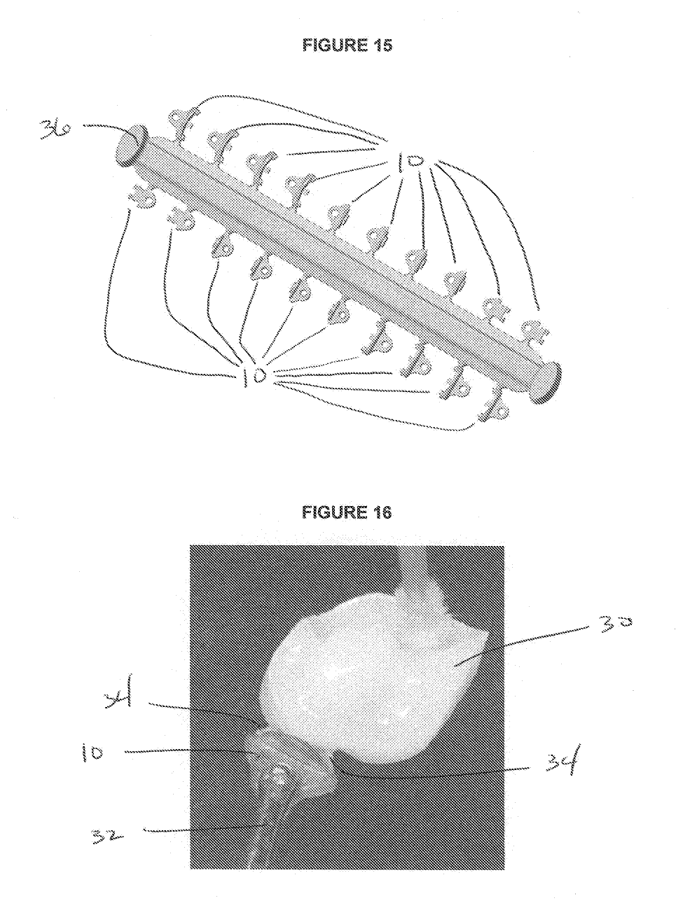

As seen in FIGS. 16-18, in operation, the dental professional will select a device 10 with an appropriately sized adhesive receiving end 12 dependent on the indirect dental restoration 30 being utilized. The device 10 is grasped by the dental professional with the assistance of dental hand tool 32. The adhesive 34 is then applied to the first adhesive receiving surface 14, second adhesive receiving surface 18 and the third and/or fourth adhesive receiving surfaces 20, 22 (depending on the configuration of the device 10). This may be accomplished by applying the adhesive directly to the device 10 or dispensing the adhesive onto an intermediate surface or container and then dipping the device 10 into the adhesive. The loaded adhesive receiving surface is then introduced to the restoration 30 and the adhesive is cured using a curing light. Using a tweezers or forces 32 the dental professional can manipulate the device 10 and restoration 30 into place by grasping the handle 16. In embodiments incorporating a bore 28 in the handle 16, a pin tweezers can be utilized to grasp the device. Once the restoration 30 is in place, the dental professional can permanently secure the restoration 30 or decouple the dental hand tool 32 and device 10 to check the positioning of the restoration. The overall dimensions of the device 10 promote the ability to decouple the device 10 from the dental hand tool 32 and accurately view the positioning of the restoration 30 without obstruction from the device 10. Once the restoration 30 is fixed in place, the device 10 and adhesive 34 can be removed by simply using a flat-sided dental instrument to loosen the adhesive from the restoration 30. As seen in FIG. 15, a plurality of devices 10 in various configurations are manufactured and packaged together on a single backbone 36 and selected by the dental professional and separated from the backbone 36 as needed.

While the present invention has been described in connection with a specific application, this application is exemplary in nature and is not intended to be limiting on the possible applications of this invention. It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

I claim:

1) A device for handling a dental restoration comprising:
a) a first adhesive receiving surface configured to receive an adhesive material;
b) a second adhesive receiving surface adjacent to and overlapping the first adhesive receiving surface;
c) a web portion interconnecting the first and second adhesive receiving surfaces; and
b) a handle adjacent the first adhesive receiving surface for grasping and handling the device.

2) The device of claim 1 wherein the handle is configured to enable grasping of the device by a dental hand tool.

3) The device of claim 1 wherein the handle further comprises a bore configured to receive the ends of a tweezers.

4) The device of claim 1 wherein the surface area of the second adhesive receiving surface area is less than the surface area of the first adhesive receiving surface.

5) The device of claim 1 wherein the first adhesive receiving surface is concave.

6) The device of claim 1 wherein the first adhesive receiving surface is substantially circular.

7) The device of claim 1 wherein the second adhesive receiving surface is substantially circular.

8) The device of claim 7 wherein the second adhesive receiving surface is concave.

9) The device of claim 1 wherein the first adhesive receiving surface is substantially oval in configuration.

10) The device of claim 9 further including a third and fourth adhesive receiving surface adjacent to and overlapping the first adhesive receiving surface wherein the surface area of the second, third and fourth adhesive receiving surfaces are each less than the surface area of the first adhesive receiving area.

11) The device of claim 10 wherein the second, third and fourth adhesive receiving surfaces comprise lugs disposed around the circumference of the first adhesive receiving surface.

12) The device of claim 10 wherein at least the second adhesive receiving surface is concave.

13) The device of claim 1 wherein the adhesive receiving surface is substantially elongated in configuration.

14) The device of claim 13 further including a third adhesive receiving surface wherein the second and third adhesive receiving surfaces comprise lugs disposed at opposite ends of the first adhesive receiving surface.

15) The device of claim 1 wherein the handle is disposed substantially perpendicular to the first adhesive receiving surface.

16) The device of claim 1 wherein the surface area of the first adhesive receiving surface is greater than the cross-sectional area of the handle.

17) A device for handling a dental restoration comprising:
a) a first adhesive receiving surface configured to receive an adhesive material and bond to the restoration; and
b) a handle adjacent the first adhesive receiving surface for grasping and handling the device
wherein the surface area of the first adhesive receiving surface is greater than the cross-sectional area of the handle.

18) The device of claim 17 further including a second adhesive receiving surface adjacent to and overlapping the first adhesive receiving surface; and an offset portion interconnecting the first and second adhesive receiving surfaces.

19) The device of claim 17 wherein the handle is configured to enable grasping of the handle by a dental hand tool.

20) The device of claim 17 wherein the handle further comprises a bore configured to receive the ends of a tweezers.

21) The device of claim 17 wherein the surface area of the second adhesive receiving surface area is less than the surface area of the first adhesive receiving surface

22) The device of claim 17 wherein the first adhesive receiving surface is concave.

23) The device of claim 17 wherein the first adhesive receiving surface is substantially circular.

24) The device of claim 23 wherein the second adhesive receiving surface is substantially circular.

25) The device of claim 24 wherein the second adhesive receiving surface is concave.

26) The device of claim 17 wherein the first adhesive receiving surface is substantially oval.

27) The device of claim 17 further including a third and fourth adhesive receiving surface are adjacent to and overlapping the first adhesive receiving surface wherein the surface area of the second, third and fourth receiving surfaces are each less than the surface area of the first adhesive receiving area.

28) The device of claim 27 wherein at least the second adhesive receiving surface is concave.

29) The device of claim 25 wherein the second, third and fourth adhesive receiving surfaces comprise lugs disposed around the circumference of the first adhesive receiving surface.

30) The device of claim 17 wherein the first adhesive receiving surface is substantially elongated in configuration.

31) the device of claim 30 further including a third adhesive receiving surface wherein the second and third adhesive receiving surfaces comprise lugs disposed at opposite ends of the first adhesive receiving surface.

32) The device of claim 17 wherein the handle is disposed substantially perpendicular to the first adhesive receiving surface.
